(19) United States
(12) Patent Application Publication
(10) Pub. No.: US 2006/0239432 A1
(43) Pub. Date: Oct. 26, 2006

(54) Automatic messaging system with caller identification feature

(76) Inventors: Patience N. Van Zandt, Santa Clara, CA (US); Thomas A. Van Zandt, San Jose, CA (US)

Correspondence Address: Thomas Van Zandt, 5255 Stevens Creek Blvd. #299, Santa Clara, CA, 95051, US

(21) Appl. No.: 11/430,825

(22) Filed: May 10, 2006

Related U.S. Application Data
(63) Continuation-in-part of application No. 10/629,393, filed on Jul. 29, 2003.
(60) Provisional application No. 60/399,510, filed on Jul. 30, 2002.

(51) Int. Cl. H04M 15/06; H04M 3/42

(52) U.S. Cl. 379/211.02; 379/142.01

(57) ABSTRACT

A method and system for providing a caller identification feature is disclosed. The caller identification feature in accordance with one embodiment of the invention identifies the number of an incoming call, compares the number to one or more numbers stored by the user, and indicates a degree of similarity between the identified number of the incoming call and one or more numbers stored by the user. For one embodiment of the invention, the number of an incoming call is identified and compared to one or more numbers stored by the user. The degree of similarity between the number of the incoming call and the one or more stored numbers is presented to the user. Based upon this information, the user provides a central site with a response instruction to the call. The central site responds according to the user's instructions.

### CROSS-REFERENCE TO RELATED APPLICATION

This application is a continuation-in-part application of U.S. patent application Ser. No. TBD, entitled “Automatic Messaging System,” filed on April, 2006 which is a continuation-in-part application of U.S. patent application Ser. No. 10/629,393 entitled “Automatic Messaging System,” filed on Jul. 29, 2003, which claims priority to provisional application Ser. No. 60/399,510, filed on Jul. 30, 2002, entitled “Automatic Messaging System,” the teachings of which are incorporated by reference herein.

### FIELD

Embodiments of the invention relate generally to the field of digital communication systems and more specifically to an automatic messaging system and a caller identification feature.

### BACKGROUND

The typical messaging service offers certain advantages over a typical telephone answering machine. For example, messages, both specific and general, can be revised by simply calling the messaging service, that is, the user does not have to reprogram an answering machine. Also, the user does not have to be concerned that the answering machine will fail to operate. Moreover, for cell phones, which have dramatically increased in use over the past two decades, all the functionality of an answering machine can not be included without unduly adding to the bulk and power consumption of the cell phone.

Typically with cell phones today, a user calls in to a central site and records an out-going message. When a caller places a call to the cell phone which is not answered, the out-going message is presented to the caller from the central site. This is similar to new telephone services that eliminate the need for a user to have an answering machine connected to a telephone. Such services allow the user to record an out-going message at a central site; the out-going message is then presented to a caller if the user does not answer their phone for a specified number of rings (e.g., 4 rings). Such systems provide some of the advantage of a messaging service (e.g., no need for an answering machine and hence no concern that the device will fail). But such services do not typically provide all the benefits of messaging services or answering machines. For example, such services do not provide for specific messages for specific callers. Or for example, a user may have the option of having his calls forwarded to his cell phone, but not want to receive many of the calls. Answering the unwanted calls may prove costly and annoying.

Conventional telephone devices provide a caller identification mechanism. Such mechanisms do not actually identify the caller, but instead recognize the number of an incoming call which is presented to a user. The user's telephone may have a number/name correspondence table (e.g., a list of stored names where each name is associated with a number) which associates the number of the incoming call with a name or other designation of significance to the user. If the number of the incoming call as identified by the caller identification mechanism matches a number that has been associated with a particular name, the name is presented to the user in lieu of the identified number. This allows a user to more easily identify and recognize the supposed caller. Because a user may typically not be presented with a number of an incoming call, but only the stored associated name or other designation, a user may no longer be able to associate a number with a name or vice versa.

Conventional telephone devices, including cell phones or other wireless communication devices, also allow a user to place a call based on the number/name correspondence table. When placing a call, the user may scroll through a list of names which are associated with a number, select a name, and thereby place a call to the associated number. Again, because of this convenience, a user may typically forget the number associated with a name or other designation.

Such a scheme has the disadvantage that when a user receives a call from a number that is not associated with a name (e.g., in the user's number/name correspondence table), a user may not recognize the significance of the identified number. For example, the user may not recognize the degree of similarity between the number of the incoming call and a number stored in the user's name/number correspondence table. Therefore, if a number of an incoming call is presented to the user, the user may respond to the incoming call in a way that would be different than if the user could recognize the degree of similarity between the number of the incoming call and one or more numbers stored in the user's number/name correspondence table. For example, when a user is presented with a number of an incoming call (e.g., through a caller identification mechanism), the user may use this information to choose between answering the call, not answering the call, responding to the call with a particular outgoing message (OGM), or other options.

### SUMMARY

An embodiment of the present invention provides a method and system for an automatic messaging service.

In response to an incoming call, a user provides a central cite with a response instruction to the call. The central cite responds according to the user's instructions. In one embodiment, a central site receives, from a remote user, one or more response instructions. During an incoming call, the user selects one of the response instructions and provides the selection information to the central site. The central site responds to the incoming call in accordance with the selected response instruction.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 is a process flow diagram in accordance with one embodiment of the present invention;

FIG. 2 is a functional block diagram of a system in accordance with one embodiment of the present invention;

FIG. 3 is a block diagram illustrating one embodiment of a processing system that may be used for the central site in accordance with an embodiment of the present invention;

FIG. 4 is a process flow diagram in which a response is provided to an incoming call in accordance with one embodiment of the present invention;

FIG. 5 illustrates a process by which a user is presented with the degree of similarity between the number of an incoming call and one or more numbers stored by the user;

FIG. 6 illustrates the presentation of the degree of similarity between the identified, but unstored, number of the incoming call and a stored number in accordance with one embodiment of the invention; and

FIG. 7 is a process flow diagram in which a response is provided to an incoming call in accordance with one embodiment of the present invention.

### DETAILED DESCRIPTION

A method and system for an automatic messaging service and caller identification feature is disclosed. Embodiments of the invention provide a caller identification feature that allows a user to assess an identified number of an incoming call that is not stored by the user (unstored). The caller identification feature in accordance with one embodiment of the invention, identifies the number of an incoming call, compares the number to one or more numbers stored by the user, and indicates a degree of similarity between the identified number of the incoming call and one or more numbers stored by the user.

An embodiment of the present invention provides a method and system for an automatic messaging service. The number of an incoming call is identified and compared to one or more numbers stored by the user. The degree of similarity between the number of the incoming call and the one or more stored numbers is presented to the user. Based upon this information, the user provides a central site with a response instruction to the call. The central site responds according to the user's instructions. In one embodiment, a central site receives, from a remote user, one or more response instructions. Upon being presented with the degree of similarity between the number of the incoming call and the one or more stored numbers, the user selects one of the response instructions and provides the selection information to the central site during the incoming call. The central site responds to the incoming call in accordance with the selected response instruction.

For one embodiment of the invention the user provides a number of recorded messages to a central site. During an incoming call the user selects one of the recorded messages based upon the degree of similarity between the number of the incoming call and the one or more stored numbers and communicates the selection information to the central site. The central site then responds to the incoming call with the selected recorded message.

In an alternative embodiment of the invention, the user selects between recorded messages provided by the user, standard recorded messages provided by a messaging service, and other response instructions including call forwarding instructions to respond to an incoming call based upon the degree of similarity between the number of the incoming call and the one or more stored numbers.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

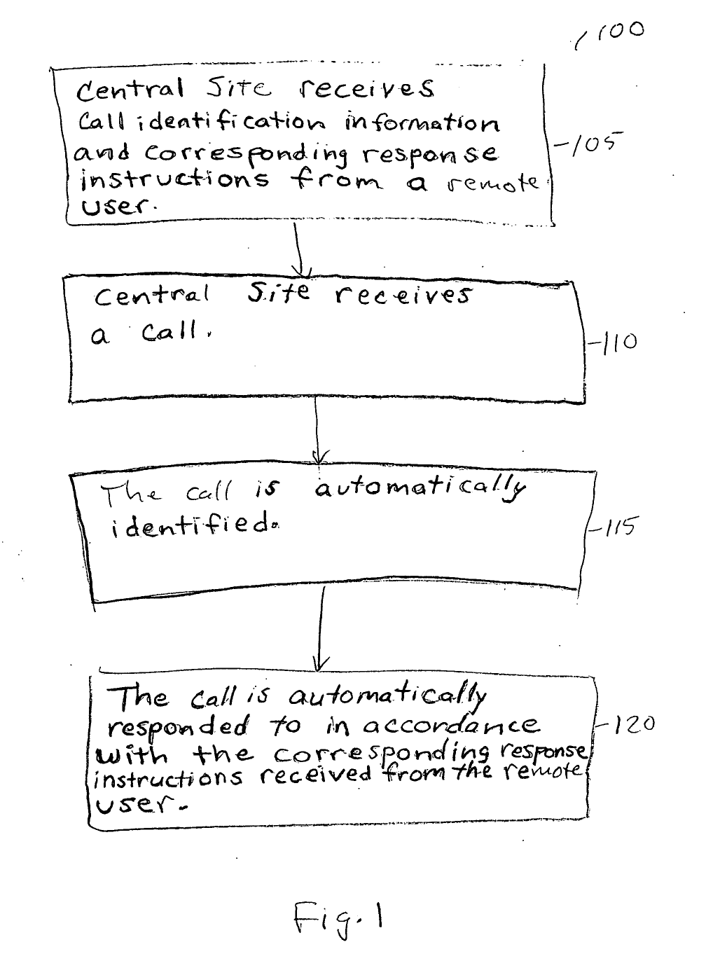

FIG. 1 is a process flow diagram in accordance with one embodiment of the present invention. Process 100, shown in FIG. 1, begins with operation 105 in which a central site receives call identification information and corresponding response instructions from a remote user. For example, a remote user may call the central site and provide call identification information in the form of an originating telephone number of the call. Alternatively, the call identification information may be a name of a prospective caller or may be a pre-arranged tonal or numeric code, or some other form of identification. The remote user also provides response instructions for the call identification information, which may be a specific recorded text, voice, and/or video message. For one embodiment, the corresponding response instructions may be to automatically forward the call to an alternative telephone number of the remote user.

At operation 110 a call is received at the central site. For one embodiment, the received call is originally placed to the telephone number of the remote user and upon a “busy signal”, or no answer at the remote user's telephone, the call is automatically forwarded to the central site.

At operation 115, the call is automatically identified. For an embodiment in which the call identification information provided by the remote user is an originating phone number of the call, the call is automatically identified through a “caller ID” mechanism. Such “caller ID” functionality is well known in the art for the purpose of call screening and/or call avoidance. For an alternative embodiment where the call identification information is a caller name, the call may be automatically identified by prompting the caller to say their name and identifying the call via a speech recognition mechanism. In a preferred embodiment, such a speech recognition system is based on overall speech patterns so that the call may be identified by comparing the remote user's input with the caller's input.

At operation 120 the call is responded to automatically in accordance with the corresponding response instructions received from the remote user. For example, the remote user may have recorded a specific message for a particular caller. In an alternative embodiment, the remote user may have instructed that a call from a particular caller be forwarded to a specified alternative telephone number of the remote user.

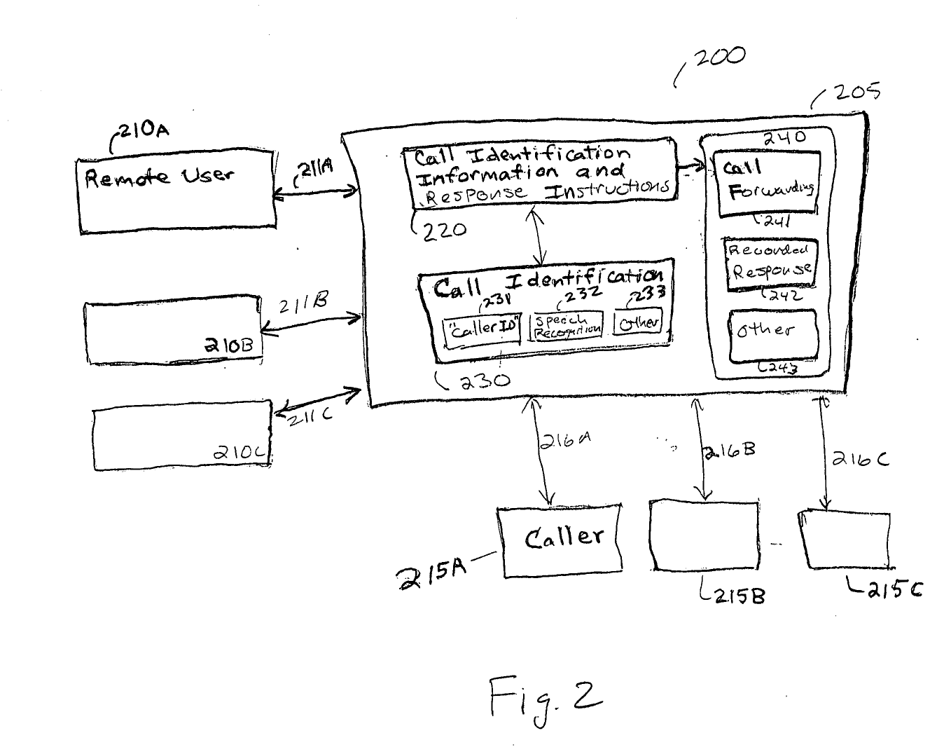

FIG. 2 is a functional block diagram of a system in accordance with one embodiment of the present invention. System 200 includes a central site 205 coupled to a number of remote users 210A-210C and a number of callers 215A-215C via communication links 211A-211C and 216A-216C, respectively. Links 211A-211C and 216A-216C may be wired or radio telephone links or network links, for example, which may communicate any combination of a number of different types of data including for example video, audio, graphics, text, multi-media or the like. For example the data may be audio/video data, such as programs with moving images and sound. However, it will be appreciated that the data files communicated in accordance with the teachings of various embodiments of the present invention are not limited only to audio/video data.

Central site 205 includes user input module 220 for receiving and storing call identification information and corresponding response instructions. Coupled to the user input module 220 is call identification module 230. Call identification module 230 uses the call identification information from user input module 220 to identify a call. Depending on the form of the call identification information, call identification module 230 may contain a number of distinct units such as caller ID unit 231, speech recognition unit 232, or other call identification functionality shown for example as unit 233.

Also coupled to user input module 220 is call response module 240. Call response module 240 uses the response instructions from user input module 220 to respond to a call. Depending on the response instructions, call response module 240 may contain a number of distinct units such as call forwarding unit 241, recorded response unit 242, or other call response functionality shown for example as unit 243.

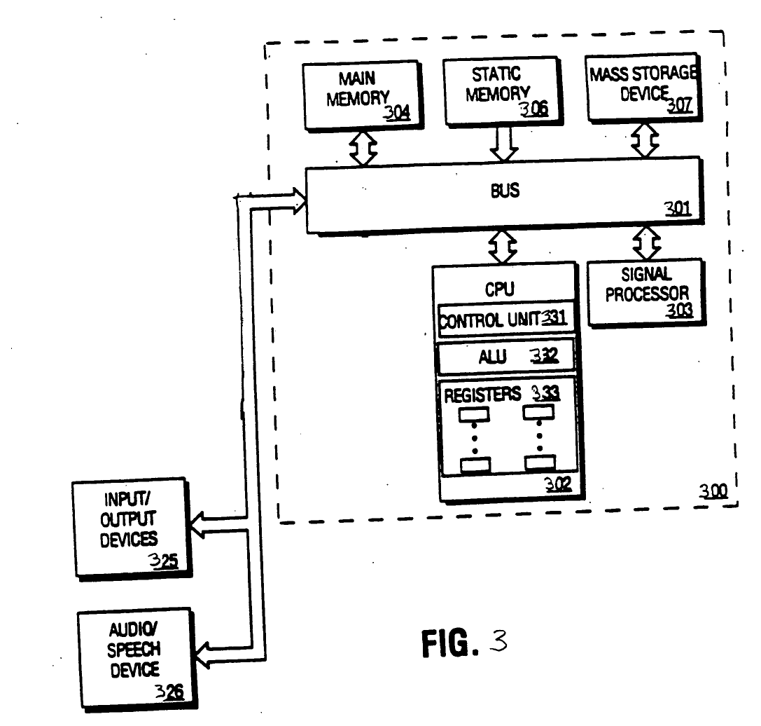

FIG. 3 is a block diagram illustrating one embodiment of a processing system 300 that may be used for the central site 205 in accordance with an embodiment of the present invention. For alternative embodiments of the present invention, processing system 300 may be a mainframe, personal, or portable computer. For one embodiment, each module of central site 205 contains a processing system.

The components of processing system 300 are exemplary in which one or more components may be omitted or added. For example, one or more memory devices may be utilized for processing system 300.

Referring to FIG. 3, processing system 300 includes a central processing unit 302 and a signal processor 303 coupled to a main memory 304, static memory 306, and mass storage device 307 via bus 301. Processing system 300 may also be coupled to input/output (I/O) devices 325, and audio/speech device 326 via bus 301. Bus 301 is a standard system bus for communicating information and signals. CPU 302 and signal processor 303 are processing units for processing system 300. CPU 302 or signal processor 303 or both may be used to process information and/or signals for processing system 300. CPU 302 includes a control unit 331, an arithmetic logic unit (ALU) 332, and several registers 333, which are used to process information and signals. Signal processor 303 may also include similar components as CPU 302.

Main memory 304 may be, e.g., a random access memory (RAM) or some other dynamic storage device, for storing information or instructions (program code), which are used by CPU 302 or signal processor 303. Main memory 304 may store temporary variables or other intermediate information during execution of instructions by CPU 302 or signal processor 303. Static memory 306, may be, e.g., a read only memory (ROM) and/or other static storage devices, for storing information or instructions, which may also bemused by CPU 302 or signal processor 303. Mass storage device 307 may be, e.g., a hard or floppy disk drive or optical disk drive, for storing information or instructions for processing system 300.

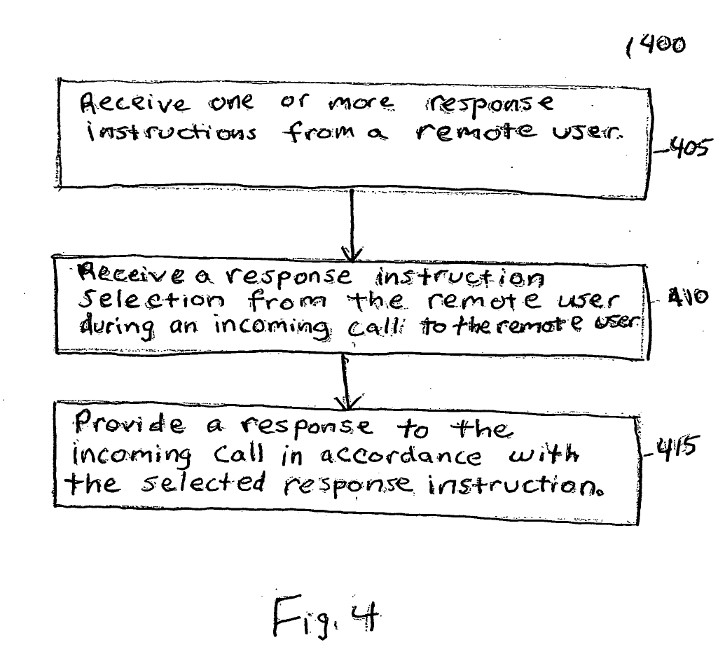

FIG. 4 is a process flow diagram in which a response is provided to an incoming call in accordance with one embodiment of the present invention. Process 400, shown in FIG. 4, begins with operation 405 in which one or more response instructions are provided to a central site by a remote user. For example, the user may provide a number of different recorded messages, such as a message that gives detailed information about where to contact the user, a message that indicates the user is preoccupied and will respond presently, a message that provides details about the user's current circumstances, etc. Additional response instructions provided by the user may include one or more numbers to which a call should be forwarded.

At operation 410 a response instruction selection is received from the user during an incoming call. For example, during an incoming call, a user may recognize the caller and determine to provide the caller with a specified response (e.g., a particular recorded message). During the incoming call, the user communicates the response instruction selection to the central site. The user may communicate the response instruction to the central site in various ways as known in the art. For example, for one embodiment of the invention the response instruction is communicated as a short message system (SMS) message. In an alternative embodiment of the invention, the user may communicate with the central site via a control channel of a cellular telecommunications system.

For one embodiment, the user accesses a menu of response instructions that have been provided to the central site. The user selects an appropriate response instruction and provides the selection information to the central site. For one embodiment, the user selects a response instruction by pressing a key or sequence of keys on the telephone keypad. For one embodiment of the invention, the user may select an appropriate response from a menu of possible responses provided on a display screen (i.e., of the user's telephone or like communication device). For one embodiment of the invention, the response instruction is created by the user during the incoming call and provided to the central site.

At operation 415 the central site provides a response to the incoming call in accordance with the selected response instruction. For example, if the selected response instruction was to forward the incoming call to a particular number, the central site forwards the incoming call to that number. Or, for example, if the selected response instruction is a particular recorded message, the central site provides the caller with the particular recorded message.

Such embodiments of the invention provide even more options to a user in dealing with incoming calls.

Embodiments of the invention provide a caller identification feature that allows a user to assess an identified, but unstored, number of an incoming call. The caller identification feature in accordance with one embodiment of the invention, identifies the number of an incoming call, compares the number to one or more numbers stored by the user, and indicates a degree of similarity between the identified number of the incoming call and one or more numbers stored by the user.

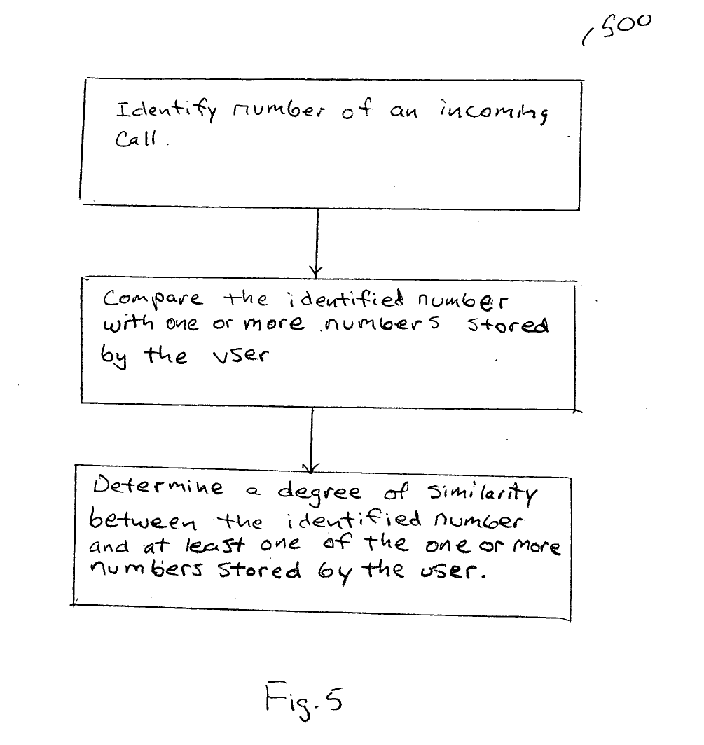

FIG. 5 illustrates a process by which a user is presented with the degree of similarity between the number of an incoming call and one or more numbers stored by the user. Process 500, shown in FIG. 5, begins at operation 505 in which the number of an unstored incoming call is identified. The number may be identified through conventional caller identification mechanisms. For purposes of this discussion, the term unstored means that the number of the incoming call is not stored in the memory of the user's telephone or other communication device, and is not stored elsewhere (e.g., at a central site) as a number associated with the user's telephone service.

At operation 510 the identified number of the incoming call is compared with one or more numbers stored by the user. Such numbers may be stored in a telephone or other communications device, or may be stored at a central site. Such number may include numbers stored in the user's name/number correspondence table. Such numbers may also include a list of recently called or recently received numbers which may also be associated with a name or other designation. Any of these numbers may be stored on the user's telephone or other communications device, or may be stored at a central site.

At operation 515 the degree of similarity between the identified number and at least one of the one or more numbers stored by the user is determined. For one embodiment of the invention, the stored number or numbers, together with an indication of each stored number's degree of similarity to the identified number is presented to the user. The user may then decide how to respond to the incoming call based upon the similarity of the number of the incoming call and one or more numbers stored by the user.

In an alternative embodiment of the invention, a specified response to the incoming call is automatically made based upon the determined similarity between the identified number and at least one of the one or more numbers stored by the user.

Comparison and display functionality may be implemented on the telephone (or other communications device) of the user (e.g., remote user 210A). For an alternative embodiment in which the user has stored numbers at a central site, the comparison functionality may be implemented on a central site DPS (e.g., central site 205).

For one embodiment of the invention the degree of similarity may be based upon each digit of the number starting with the left most digit. For example, if the identified number of the incoming call is (408) 555-1234 and the user has stored numbers (408) 555-1235 and (408) 555-1000, then these two numbers will be presented to the user. The number (408) 555-1235 will be indicated as having a degree of similarity of 9 and the number (408) 555-1000 will be indicated as having a degree of similarity of 7.

In an alternative embodiment of the invention, a typical telephone number format will be segmented and the degree of similarity will be indicated in terms of each of the segments.

For example, a typical telephone number format is a three-digit area code, a three-digit prefix, and four additional digits. Such numbers can be viewed as having three segments. For one embodiment of the invention, the number of segments matched indicates the degree of similarity. For example, if the identified number of the incoming call is (408) 555-1234 and the user has stored the number (408) 555-1235 then this number will be presented to the user with an indicated degree of similarity of 2. For one such embodiment of the invention, if one or more digits of the final segment match, the degree of similarity may be indicated as a fractional value.

For example, if the identified number of the incoming call is (408) 555-1234 and the user has stored numbers (408) 555-1235 and (408) 555-1000, then these two numbers will be presented to the user. The number (408) 555-1235 will be indicated as having a degree of similarity of 2.75 and the number (408) 555-1000 will be indicated as having a degree of similarity of 2.25.

For one embodiment of the invention, unless a specified threshold minimum number of digits starting and continuing from the left most digit are the same, the stored number will be determined not to have a sufficient degree of similarity to be presented to the user. For one such embodiment, if the area code of the identified number of the incoming call does not match a stored number, then no stored numbers will be determined to have a sufficient degree of similarity to be presented to the user. For one such embodiment of the invention, stored numbers will be formatted consistently with the identified number of the incoming call prior to comparison. For example, stored without area codes may be reformatted with an area code based upon the user's telephone service location or address. For example, many users store numbers without an area code, if the number has an area code that is the same as the user's phone service or corresponds to the user's locale of use. Such stored numbers may have an appropriate area code (e.g., the user's local area code) added as a prefix before comparison with the identified number of the incoming call.

For one embodiment of the invention, at most a specified maximum number of stored numbers is presented to the user with the most similar stored numbers presented. For another embodiment of the invention, only the stored numbers having the highest degree of similarity are presented to the user. For example, if the user has stored several numbers having a degree of similarity to an identified number of at least six digits and two that have a degree of similarity of nine digits, then only the two having a degree of similarity of nine digits will be presented.

For one embodiment of the invention a shaded bar or other graphical representation can be used to indicate the degree of similarity between the identified number of the incoming call and one or more numbers stored by the user.

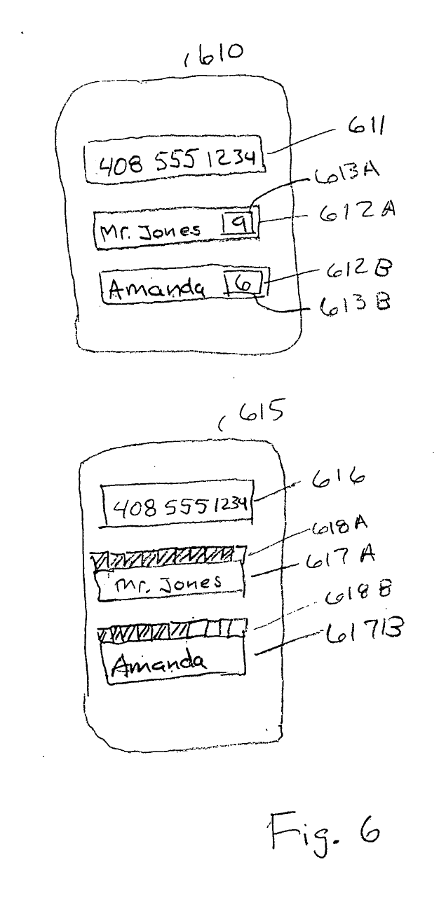

FIG. 6 illustrates the presentation of the degree of similarity between the identified, but unstored, number of the incoming call and a stored number in accordance with one embodiment of the invention. As shown in FIG. 6, display 610, which may be the display of a telephone or other communications device, has a display area 611 that displays the identified number of the incoming call. Display area 612A displays a name (i.e., Mr. Jones) corresponding to a number (not shown, but for example (408) 555-1235). This name and number pair may be stored in a name/number correspondence table. Display area 613A indicates the degree of similarity between the identified number of the incoming call, displayed in display area 611, and the number corresponding to the name displayed in display area 612A. As shown for example, the degree of similarity is indicated by the number of digits that are the same starting from the left most digit, and is “9” for “Mr. Jones”. A second display area 612B of display 610 displays another name (i.e., Amanda) corresponding to a number (not shown, but for example (408) 555-2000). Display area 613B indicates the degree of similarity, “6”, between the identified number of the incoming call, and the number corresponding to the name displayed in display area 612B.

Likewise, display 615 has a display area 616 that displays the identified number of the incoming call and display areas 617A and 617B that display names corresponding to numbers. Display areas 618A and 618B indicate the degree of similarity between the identified number of the incoming call, displayed in display area 615 and the number corresponding to the name displayed in display areas 617A and 617B, respectively, as a shaded bar shown for example as display areas 618A and 618B. As shown, display 618A indicates a degree of similarity of nine, while display 618B indicates a degree of similarity of six.

The user can use the information provided by embodiments of the invention to make decisions about how to handle an incoming call and make assessments as to the caller's identification. For example, many large organizations employ a bank of telephones each having a different, but similar corresponding number. When a member of such an organization places a call, the call may be routed through any of the many telephones and therefore may not be recognized by the party being called, although it may be quite similar. For example, a husband may have his wife's work phone number stored in his cell phone. The number may be associated with a name or designation (e.g., “shewhomustbeobeyed”). When his wife calls, the name or designation is presented as the incoming caller. For this reason the husband is not familiar with his wife's work telephone number. Therefore, when a call from his wife is routed through a different, unstored, but similar, telephone number, the husband receives no indication that his wife is calling, but instead a number that he does not recognize. Using an embodiment of the present invention, the husband will now receive an indication that the incoming call is from his wife, or at least that it is likely the call is being placed from her organization.

Or for example, a father may have a daughter who lives out of town at college in Nebraska. The father may have his daughter's phone number stored in his cell phone. The number may be associated with a name or designation (e.g., “Mans”). When his daughter calls, the name or designation is presented as the incoming caller. For this reason the father is not familiar with his daughter's telephone number. However, it may be that the father does not typically receive telephone calls from Nebraska. Therefore, when a call comes in from an unstored number that is identified as having a “402” area code, it will be indicated to the father as having a degree of similarity to his daughter's telephone number. The father may then assess whether the incoming call is either from, or regarding, his daughter, even though it is not from her number. The father may then wish to respond to the call in some desired way based upon the identified number of the incoming call.

As discussed above, embodiments of the invention allow a user to respond to an incoming call based upon the similarity between the identified, but unstored, number of the incoming call and a stored number (e.g., a number stored in the user's name/number correspondence table).

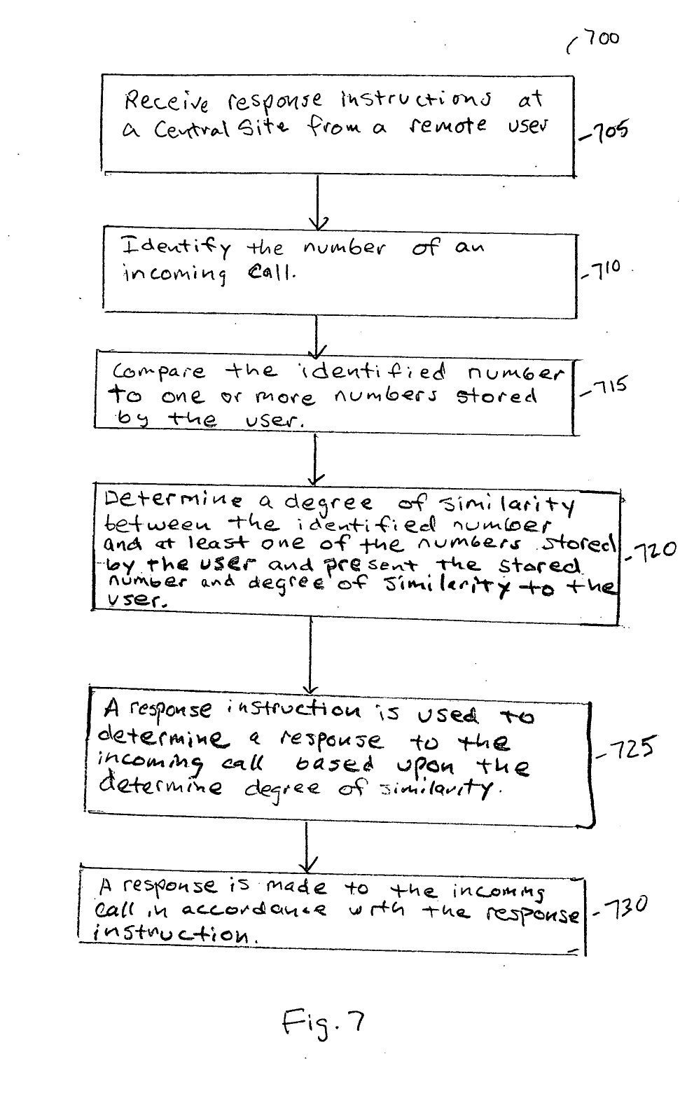

FIG. 7 is a process flow diagram in which a response is provided to an incoming call in accordance with one embodiment of the present invention. Process 700, shown in FIG. 7, begins with operation 705 in which one or more response instructions are provided to a central site by a remote user. For example, the user may provide a number of different recorded messages, such as a message that gives detailed information about where to contact the user, a message that indicates the user is preoccupied and will respond presently, a message that provides details about the user's current circumstances, etc. Additional response instructions provided by the user may include one or more numbers to which a call should be forwarded.

At operation 710 the number of an incoming call is identified (e.g., through conventional caller identification mechanisms).

At operation 715 the identified number of the incoming call is compared to numbers stored by the user.

At operation 720 the degree of similarity between the identified number of the incoming call and at least one or more numbers stored by the user is determined and presented to the user. For one embodiment of the invention, the user may be presented with two or three stored numbers that are most similar to the identified number of the incoming call as well as the degree of similarity of each.

At operation 725 a response instruction is used to determine a response to the incoming call based upon the degree of similarity between the identified number of the incoming call and one or more numbers stored by the user. For one embodiment of the invention, the response instruction may be received from the user during the incoming call as described above in reference to FIG. 4. In an alternative embodiment of the invention, the response instruction may have been previously provided to the central site by the user. For one such embodiment of the invention, a response to the incoming call in accordance with the previously provided response instructions may be made automatically when the identified number of the incoming is determined to have a specified threshold degree of similarity to a number stored by the user.

At operation 730 a response is made to the incoming call in accordance with the selected response instruction. For example, if the selected response instruction was to forward the incoming call to a particular number, the central site forwards the incoming call to that number. Or, for example, if the selected response instruction is a particular recorded message, the central site provides the caller with the particular recorded message.

General Matters

Therefore, using embodiments of the invention, the user may assess an identified but unstored number of an incoming call. The caller identification feature in accordance with one embodiment of the invention identifies the number of an incoming call, compares the number to one or more numbers stored by the user, and indicates a degree of similarity between the identified number of the incoming call and one or more numbers stored by the user.

An embodiment of the present invention provides a method and system for an automatic messaging service. The number of an incoming call is identified and compared to one or more numbers stored by the user. The degree of similarity between the number of the incoming call and the one or more stored numbers is presented to the user. Based upon this information, the user provides a central site with a response instruction to the call. The central site responds according to the user's instructions. In one embodiment, a central site receives, from a remote user, one or more response instructions. Upon being presented with the degree of similarity between the number of the incoming call and the one or more stored numbers, the user selects one of the response instructions and provides the selection information to the central site during the incoming call. The central site responds to the incoming call in accordance with the selected response instruction.

For one embodiment of the invention the user provides a number of recorded messages to a central site. During an incoming call the user selects one of the recorded messages based upon the degree of similarity between the number of the incoming call and the one or more stored numbers and communicates the selection information to the central site. The central site then responds to the incoming call with the selected recorded message.

In an alternative embodiment of the invention, the user selects between recorded messages provided by the user, standard recorded messages provided by a messaging service, and other response instructions including call forwarding instructions to respond to an incoming call based upon the degree of similarity between the number of the incoming call and the one or more stored numbers.

Embodiments of the invention have been described as including various operations. Many of the processes are described in their most basic form, but operations can be added to, or deleted from, any of the processes without departing from the scope of the invention. For example, an embodiment of the invention is described, in reference to FIG. 4, in which a response is provided to an incoming call based upon a response instruction selected during the incoming call. For one embodiment of the invention, the response instruction selection may be regard to a number of standard responses response options provided by a messaging service. Therefore, for some embodiments of the invention, operation 405 is unnecessary.

Embodiments of the invention include various operations. The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central site or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
identifying a number of an incoming call to determine an identified number, the identified number unstored;
comparing the identified number to one or more numbers stored by a user; and
determining a degree of similarity between the identified number and at least one of the numbers stored by the user.

2. The method of claim 1, wherein each of the at least one number has an associated designation, further comprising:
presenting the associated designation of at least one of the numbers for which a degree of similarity with the identified number has been determined; and
presenting the determined degree of similarity for each number associated with a presented designation.

3. The method of claim 1, further comprising:
automatically responding to the incoming call based upon the degree of similarity between the identified number and at least one of the numbers for which a degree of similarity with the identified number has been determined.

4. The method of claim 2 further comprising:
receiving, at a central site, a response instruction selection from a remote user, the response instruction selection selecting one or one or more call responses; and
providing a response to the incoming call in accordance with the selected response instruction.

5. The method of claim 2 wherein a response to the incoming call is created by the user, during the incoming call, the response based upon the determined degree of similarity between the identified number and at least one of the numbers for which a degree of similarity with the identified number has been determined.

6. The method of claim 2 wherein the degree of similarity for each number associated with a presented designation is presented as a graphical representation.

7. A system comprising:
means for identifying a number of an incoming call to determine an identified number, the identified number unstored;
means for comparing the identified number to one or more numbers stored by a user; and
means for determining a degree of similarity between the identified number and at least one of the numbers stored by the user.

8. The system of claim 7, wherein each of the at least one number has an associated designation, further comprising:
means for presenting the associated designation of at least one of the numbers for which a degree of similarity with the identified number has been determined; and
means for presenting the determined degree of similarity for each number associated with a presented designation.

9. The system of claim 7, further comprising:
means for automatically responding to the incoming call based upon the degree of similarity between the identified number and at least one of the numbers for which a degree of similarity with the identified number has been determined.

10. The system of claim 8 further comprising:
means for receiving, at a central site, a response instruction selection from a remote user, the response instruction selection selecting one or one or more call responses; and
means for providing a response to the incoming call in accordance with the selected response instruction.

11. The system of claim 8 wherein a response to the incoming call is created by the user, during the incoming call, the response based upon the determined degree of similarity between the identified number and at least one of the numbers for which a degree of similarity with the identified number has been determined.

12. The system of claim 8 wherein the degree of similarity for each number associated with a presented designation is presented as a graphical representation.

13. A machine-readable medium that provides executable instructions, which when executed by a processor, cause the processor to perform a method, the method comprising:
identifying a number of an incoming call to determine an identified number, the identified number unstored;
comparing the identified number to one or more numbers stored by a user; and
determining a degree of similarity between the identified number and at least one of the numbers stored by the user.

14. The machine-readable medium of claim 13, wherein each of the at least one number has an associated designation, the method further comprising:
presenting the associated designation of at least one of the numbers for which a degree of similarity with the identified number has been determined; and
presenting the determined degree of similarity for each number associated with a presented designation.

15. The machine-readable medium of claim 13, wherein the method further comprises:
automatically responding to the incoming call based upon the degree of similarity between the identified number and at least one of the numbers for which a degree of similarity with the identified number has been determined.

16. The machine-readable medium of claim 14, wherein the method further comprises:
receiving, at a central site, a response instruction selection from a remote user, the response instruction selection selecting one or one or more call responses; and
providing a response to the incoming call in accordance with the selected response instruction.

17. The machine-readable medium of claim 14 wherein a response to the incoming call is created by the user, during the incoming call, the response based upon the determined degree of similarity between the identified number and at least one of the numbers for which a degree of similarity with the identified number has been determined.

18. The machine-readable medium of claim 14 wherein the degree of similarity for each number associated with a presented designation is presented as a graphical representation.
